(19) United States
(12) Patent Application Publication
(10) Pub. No.: US 2014/0345603 A1
(43) Pub. Date: Nov. 27, 2014

(54) PROCESS FOR COMMERCIAL PRODUCTION OF CONCENTRATED SUGARY SYRUP WITH LOW ENERGY REQUIREMENT

(71) Applicant: Valerie Gay Chadbourne, Ontario (CA)

(72) Inventor: Valerie Gay Chadbourne, Ontario (CA)

(21) Appl. No.: 14/455,496

(22) Filed: Aug. 8, 2014

Related U.S. Application Data
(63) Continuation-in-part of application No. 12/778,803, filed on May 12, 2010, now abandoned.

(51) Int. Cl. C13B 20/16

(52) U.S. Cl. CPC C13B 20/16
USPC 127/53

(57) ABSTRACT

The invention provides a progressive freeze-concentration process for the commercial production of sugar, particularly maple, syrup including the steps of exposure of collected raw sugar solutions and maple sap on-site to a predominantly or relatively naturally occurring cold surface, gradually cooling the sap to a temperature sufficient to commence freezing of a water ice, continuing the cooling and freezing to form a solid body of water ice and a liquid component separate from the solid body containing first sugars, continuing the cooling and freezing until the first sugars containing liquid component reaches a substantially thickened or gel consistency, and thirdly, separation of the first sugars containing liquid component from the said solid body.

### RELATED U.S. APPLICATION

This application is a continuation-in-part of U.S. application Ser. No. 12/778,803 filed May 12, 2010, entitled PROCESS FOR COMMERCIAL PRODUCTION OF CONCENTRATED SUGARY SYRUP WITH LOW ENERGY REQUIREMENT, pending, the disclosure of which is incorporated herein by reference.

### FIELD OF THE INVENTION

The present invention relates to the progressive freeze concentration process for production of sugar, particularly maple, syrup and the sugar and maple syrup products which result. In particular, the process provides a multiple step water extraction process driven by predominantly natural gradual freezing and thawing cycles applied to the collected raw sugar solutions or maple sap and separation of the resulting components before heat treatment.

### BACKGROUND OF THE INVENTION

It has long been the maple syrup industry common practise to gather sap from maple trees by a variety of methods. The raw sap is collected into one or more central reservoirs. Then the water content of the bulk sap is greatly reduced by boiling or evaporation, alone or in combination with reduced atmospheric pressure. In simpler manual systems the reservoir may be as simple as a bucket on a spigot at the individual tree while in more complex ones there are extended collection systems running from many trees to a single central location.

In the earliest days of mass production the sap collection was done by manual labour as individual buckets where removed from individual tree spigots and transported individually to a central location where reduction occurred over a wood burning fire. As demand and labour costs both rose the industry turned to these multi-point collection systems and improved thermal reduction with alternative fuels such as electricity and gas.

Further increases in demand and in costs resulted in improved equipment and processes for the reduction of the sap into the high sugars syrup demand in the marketplace. For the most part these improvements have been to further mechanize the process and provide bulk energy sources. While effective, these mechanizations bring with themselves a whole host of problems, solutions and, typically, much higher capital and operating costs while reducing the manual labour (skilled or unskilled) component.

There are several predetermined factors:

Maple Sap has approximately 3% pure sugar content,

Maple Syrup has approximately 66%-67% sugar,

The ratio of sap to syrup in typical production is 40-1. Thus, it takes 40 liters of maple sap to produce 1 liter of Maple syrup by means of conventional syrup production,

The freezing point of maple sap is lower than that of water, and

In ideal temperature conditions, maple sap runs effectively only when the ambient temperature is below −5 degree ° C. at night and no more than +5 degree ° C. during the day. A night time temperature of below about −5 degree C. is required for the sap to run in the trees themselves when the day warms up. A maximum effective daytime temperature of about +5 is required as the sap turns bitter as the trees begin to grow.

When hardwood fuel is used for thermal evaporation by boiling a standard cord (4′×4′×8′) will produce enough heat to make 68 litres (15 gallons) of maple syrup.

With oil fired evaporators it usually requires the heat from three to four litres (0.7 gallons-0.9 gallons) of fuel oil to make a single litre of maple syrup. Occasionally, a production efficiency of 1 litre of maple syrup for each litre of oil consumed has been achieved.

These processes are not known to be used for the production of other types of sugar syrup, sugar or sugar concentrate in which the plants themselves are typically mechanically collected in bulk form (harvested) and then shipped to a mechanized processing facility.

### BACKGROUND OF THE INVENTION

The current mechanized processes of producing maple products by intense heat and evaporation methods, without more, hold back the growth of the maple industry and are not widely used for other sugars because it is currently energy intensive and time consuming thereby making these products expensive to produce. This in turn limits the prospects for the vast array of food and other products that could potentially be brought to manufacture and market as raw materials or as fully finished consumer or industrial products such as speciality industrial or consumer sugars, maple syrup and maple sugar. The reduction process is thermally generated with or without a reduced ambient pressure (vacuum) to assist.

It is reported that as much as 300 years ago European settlers found aboriginal peoples making a crude dark sugar from maple sap. They collected the sap from tree wounds in birch bark buckets. Next, water was driven off the sap by boiling the mixture until the sugar was made. Hot stones were thrown into hollowed-out basswood logs or, possibly, earthenware containers, filled with maple sap to cause quick evaporation before the sap spoiled. The prior art shows that an alternative was to add water to the sap and then to allow this diluted sap to freeze within its containing birch bark bucket and thereafter dispose of the layer of ice which formed on the upper exposed surface of the sap overnight. The frozen layer could then be broken off mechanically, leaving a contained volume of liquid within the bucket. This later technique, although reported in a single instance, is not known the by the present inventor to be operative at the relevant time and is not known to have been in use since any aboriginal origins, if at all, notably by reason of the addition of water to the sap before processing and subsequent research. As far as this may be understood this was probably for preservative purposes as it appears that much of sugars product so laboriously and expensively collected would be thrown away and thermal evaporation would remain as the next processing step. Typically freezing was used to store the sap until sufficient quantities are collected for thermal processing as the sap will spoil if not treated quickly.

Such birch bark buckets are expected to operate in the fashion of a birch bark canoe but in reverse. A bark canoe is typically formed of a single layer of bark itself much like a laminate with the water impermeable surface layer (formed between the outer bark and the standing tree) to the exterior of canoe and with the outer bark layer inside. The exterior surface in contact with the water (the water excluding exterior surface) would tend to exclude water penetration. The interior canoe surface, comprising the outer bark layer, would protect the water impermeable layer and the contents of the contained volume of the canoe by the porous and strong outer bark.

In the case of a liquid bark container, the water impermeable layer would be on the inside so as to contain the liquid contents within a containing surface, somewhat less than the full interior as the bucket would not be completely full, and also separate from an insulating porous air-trapping outer layer. The outer layer is formed by the exterior portion of the bark of the tree (on the outer surface of the container).

European settlers improved on collection methods at the tree and used wooden buckets to collect the sap. The sap was initially boiled in iron kettles and later in flat bottomed pans. By the early's a flue type evaporator became common. Deep corrugations in the bottom of the pan provided a large area of contact between the fire and the pan thus boiling the sap more quickly. All of these assume the ready availability of a high quantity of thermal energy such as would be available from a wood or gas fire.

It is not widely understood that naturally occurring sugar syrups such as maple syrup are biologically active to very active at temperatures as low as 4.5 degree° C. This biological activity can manifest itself at any stage of harvest, collection, processing, storage and consumption. The prior art and industry standards suggests that the most effective way of combating this biological degradation is to maintain low temperatures for storage and transport and to subject the syrup to high (boiling) temperatures for the purpose of sterilization as well as for reduction.

More efficient systems to process sap into maple syrup have been developed since about 1950 and in the 1970's reverse osmosis processing (RO) was introduced. By using RO technology the sugar concentration in raw sap is increased from about 2-3 percent to about 8 percent or more before the sap is boiled to produce syrup. The primary benefit of this RO process is to greatly reduce the energy input required for effective production. Reverse osmosis as far as is known by the present inventor can reduce the water content from the sap by as much as 75%. In place of the energy costs and the existing on-site equipment RO processing requires a whole new type and quantity of specialized and expensive equipment with sensitive membranes and the like. In addition to the electrical power required for operation, and the greatly increased capitalization, skilled and highly trained work persons are needed to satisfactorily operate this equipment on seasonal basis. As a result, RO technology has not taken a significant hold, especially among smaller operatives.

Unfortunately, with all known operating methods much of the lighter fractions of the natural maple sap are simply allowed to evaporate to atmosphere as they are driven off by heat from thermal evaporation at ambient atmospheric pressure or below.

It is known that sap in collection systems may freeze overnight in suitable conditions and require thawing out as the day warms up for transport and evaporation as discussed in Canadian Patent 1,323,986 to Chabot. This technique is primarily used for preservation of the sap while collection continues until suitable processing volumes are reached. Chabot teaches the heating of the exterior piping by low angle sunlight while preventing the stronger rays of mid day sun from raising the temperature too high. Its point is to enhance the flow of liquid sap in the piping system by selectively heating the exterior of the piping.

In unrelated arts it is known that freeze drying processes are effective for the mass production of concentrated fruit and vegetable juices but these are technologically and economically complex systems involving inert gases and the removal of substantially pure ice crystals from the mix. Portions are then recombined with the original liquid to return flavour and substance to the result such as are discussed in U.S. Pat. No. 4,463,025 issued Jul. 31, 1984 to Strobel, U.S. Pat. No. 6,254,913 issued Mar. 7, 2001 to Wadsworth.

While freeze distillation and its companion, freeze concentration, are known techniques but their application to taste sensitive food products has been problematic. An example is fruit juice and ice beer as described in US RE36,897. Another is described in Canadian patent 673,672 wherein freeze concentration is used to improve upon the traditional beer making process. As described, the process requires the formation of semi-frozen slurry of liquid and ice crystals from which the ice crystals are removed in an inert atmosphere.

A further is described in Canadian patent 601,487 wherein freeze concentration is described in respect of a variety of liquids such as juice, beer, wine, resins, coffee, milk and pharmaceuticals wherein a low differential of temperature is provided between the freezing solution and the coolant. The process involves stepwise progressive freezing with the result being fine solvent (water) crystals and removal of those crystals at low differentials of temperature (5-7 degrees ° F.). Ice crystals are removed stepwise. In most prior cases referred to the quantity of heat transfer and, thus, formation of ice, is large and presents an entirely different technical problem. In both cases the common element is slurry from which ice crystals are removed.

Yet again in Canadian patent 710,662 issued 1965 the process for freeze concentration is described as the formation of semi-frozen slurry of frozen component and solvent. There it is the extraction of the solvent from the slurry which presents the main technical issue as too much solvent remains.

In all of the above examples the technique has been to form semi-solid slurry of unfrozen solvent and ice crystals by rapid reduction in the temperature of the solution either with a high or low temperature differential freezer.

As far as the present inventor is away the technical focus has been upon the rapidity and cost of production of suitable ice crystal slurry without product degradation. Reported efforts have included high temperature differential rapid freezing and as a low cost alternative a low temperature differential but high thermal transfer apparatus.

In most known cases in the prior art these efforts have not been suitable in result despite the high capital investment and high energy costs encountered. This is particularly so where a multi-step process is described.

While it is the quality of the end product which causes most efforts to fail it is also noted in the prior art that solids handling is a problem as solids can't be pumped or compressed. Mechanical manipulation of the solid wears away at machinery as freezing will occur wherever conditions are favourable, particularly along the tank and machinery walls necessary for mechanized production. It is also noted that solids do not diffuse well. Freezing produces temperature gradients and it is known that impure solid products result. This is noted at www.half bakery.com/idea/freeze_{—}20 Distillation.

It is noted by one author in 1950 that freeze concentration generally does not result in a product which has the characteristic colour, flavour, or aroma of even the thermally generated typical maple syrup. The author notes that the true maple flavour and amber colour are developed by boiling.

All of this prior art has been ignored by recent Japanese researchers pursuing an efficient means of freeze-concentration in sugary solutions. As late as the 80's and 90's Japanese researchers have outlined efforts to effectively operate progressive freeze-concentration in sugary solutions by starting and growing a single crystal body of water ice directionally into a sugary solution. These researchers present 2 progressive freezing options. Firstly, a 2-step method is presented where a water ice layer is formed from pure water onto a surface, the remaining water removed and replaced with the target sugar solution. Secondly, a stirring method is presented where a sugary solution is exposed to a surface maintained at −15 degrees Celsius and a rapidly stirred in a regular manner to grow the water ice body on that surface. These specifically teach the need for rapid stirring for the processes presented to work at all.

None of such processes are known to be suitable for usage in a sugar bush as, typically, the sugaring off process occurs within a short distance from the point of collection.

### SUMMARY OF THE INVENTION

An objective of the sugar concentration process invention is to effectively separate water from the sugar in a sugar solution, such as maple sap, and provide for the practical application of alternative energy use in the manufacturing of sugar or maple syrup products.

Another objective of the invention is to provide an energy efficient and effective way to controllably and successfully separate and remove water from raw, as collected on site, sugar solutions and maple sap.

A further objective is to provide a water elimination process which promotes the environmentally clean harvesting and production of sugary solutions from plants such as tree sap and the lessening of the current industry's costly and energy intense carbon footprint by as much as an estimated 90%.

A still further objective of the process of the invention is to provide for on-site extraction in a manner which may be simply and economically incorporated into existing production infrastructure with a broad allowance for the manufacturers needs without further capitalization of expensive and technically complicated equipment or the requirement for further and other labour skills and replaceable parts. A calculation of the manpower and time requirements for a simple boiling procedures resulting in major reduction in volume, leaving out capitalization and profit requirements, demonstrates the substantial cost component of production compelling automated mechanical bulk procedures.

A still further objective is to provide an extraction process which uses the natural climatic freeze and thaw process of production days in early spring to progressively freeze-concentrate sugary solutions such as maple sap into a syrup.

A still further objective is to provide a process whereby full use of all of the original sap characteristics and flavours harvested or collected from trees is maintained without significant thermal degradation, unlike the conventional maple sugar harvesting method that evaporates lighter fractions. The traditional method of burn off evaporates away some sugars and lighter materials along with the harvested water or tree water during the heating process.

Another objective is to provide a process whereby the quality of sugars obtained may be maintained in controlled portions thereby allowing the sap to be easily manipulated to suit the regional and global market demand.

A still further objective is to avoid the traditional method of burn off, with or without pressure reduction, as these processes evaporate some sugar and other ingredients away along with the water lost during the heat processes.

Another object is to maintain the temperature of the sap throughout the entire processing steps as low as possible but not below about 4.5 degree C. so as to avoid substantial biological activity whether pre-filtered or not.

It is yet another objective of the invention is to manage the removal of water from the collected raw sap in a shorter processing time thereby making alternative energy sources such as passive or photovoltaic solar on site energy a viable option in completing the solution or maple syrup process due to the substantial reduction in total energy requirements on site and use of all available on site energy resources.

It is a still further objective to provide an improved method of sugar solution or maple sap reduction which may be operated effectively during the extremely short production season in a wide variety of small to medium size maple forest or harvest locations and thereby expand total production while remaining within the existing means of the small to medium sized operator in a market for which it is believed that demand plus potential demand far exceeds available supply.

It is an even further object of the invention to provide a naturally generated maple syrup product with a beautiful amber colour with higher Brix numbers having better colours and taste which can be pre-filtered so as to remain bacteria free with a high clarity after weeks without refrigeration.

### DESCRIPTION OF THE PRESENT INVENTION

The process of the present invention provides for directional and gradual progressive freezing of the raw sap solution upon and away from the containing surface (define what is containing surface interior or exterior surface) of a bulk container and towards an uncontained surface (define the term) exposed to ambient air conditions rather than the opposite, namely, freezing from the exposed uncontained surface into the body of the raw sap.

Gradual freezing provides for the progressive freezing of an initial layer of substantially pure water ice onto the cold containing surface and from there the increasing of the initial layer into a solid body of substantially pure water ice secured to the cold containing surface and the initial layer. Preferably this occurs by the use of a heat conductive bulk container, such as a metal receptacle, with an open end exposed to the ambient atmosphere at a typical harvesting site. Gradual temperature reduction of the bulk container is preferably at a rate of no more than 2 Celsius degrees per hour, alternatively no more than 1 Celsius degrees per hour and further alternatively no more than 0.5 Celsius degrees per hour. As heat is exhausted from the syrup into the containing wall of the bulk container the temperature and state of the syrup adjacent that wall gradually starts and continues to change. The process of the invention preferably slowly forms a frozen layer of substantially pure water ice on the interior containing surface which then grows by progressive freezing into the body of collected sugary solution as substantially pure water ice. Increasing the rate of cooling by decreasing the temperature of the containing surface too rapidly or by drawing away heat too quickly increases the concentration of sugars in the forming ice to the point where the whole of the sugars solution freezes without concentration.

Preferably, the bulk container of the invention is a simple metal bucket typical of maple tree sap collection or a larger bulk container. Preferably, for a fully natural use of the invention the container is formed of a thin metal sufficiently heat conductive to that its internal surface is at and remains at the ambient outside temperature without additional cooling. Further preferably, the container is only partially full so that its interior provides a liquid containing surface. The remainder of the interior surface provides an additional heat sink for the liquid to ambient heat transfer to occur as the ambient temperature decreases.

For less conductive bulk containers, preferably additional cooling of the containing surface is required in a manner known in the art, alone or in combination with a slightly elevated temperature in the volume of liquid. The method of progressive freeze-concentration of raw sugary syrup comprises the steps of collecting a volume of a raw sugary syrup within a cold containing surface; exposing the raw syrup to the cold containing surface; then gradually reducing the temperature of the cold containing surface from the freezing point of water into ice towards −4.5 degrees Celsius; gradually cooling the raw syrup by the cold containing surface to commence freezing out of water ice only on the cold surface; continuing the gradual cooling of the raw syrup to progressively freeze-form a solid body of water ice inwardly from the water ice frozen out on the containing surface; maintaining the volume of sugary syrup as a liquid substantially free from ice crystal formations as a sugars containing liquid component separate from the solid ice body; continuing the gradual cooling and progressive freeze-forming until the sugars containing liquid component reaches a thickened consistency; maintaining the solid body of the water ice and mechanically or thermally separating the sugars containing liquid component from the solid body.

Preferably the method of gradual temperature reduction is provided by a naturally occurring spring heat and thaw cycle at a rate of 2 Celsius degrees per hour or less.

Further preferably the method of progressive freeze-concentration includes a containing cold surface is heat conductive and the gradual cooling and progressive freeze-forming is preferably upwardly from the cold containing surface into the liquid component. The liquid component is preferably maintained at a temperature slightly higher than the containing surface or in a condition where heat loss is primarily or solely to and through the cold containing surface and further preferably motionless.

Alternatively or additionally, the sugars containing liquid component is also exposed to a non-containing ambient atmosphere and the thickened consistency forms at an upper surface exposed to the ambient atmosphere.

Preferably the solid body of water ice is substantially pure water or, alternatively, contains an reduced amount of sugars than the sugars in the liquid component.

The progressive freeze-concentration process of the invention can reduce water content in sugar solutions and maple sap on site to any required sugars measurement in a clean and naturally occurring way which can be readily enhanced, if required. Water reduction by the progressive freeze-concentration process using the natural freeze thaw spring cycle can be as much as 20% more efficient than the reverse osmosis (RO) process and provide a 75% water reduction or more.

Thus, undesired water is reduced to levels required by further processing steps (such as caramelizing and sterilization) in order to achieve the goal of a finished sugar or maple syrup with ⅓ water and ⅔ sugars.

The invention preferably provides a process for the production of sugar or maple syrup and the syrup product produced comprising the steps of, firstly, collecting raw harvested sugar solution or maple sap (herein ‘sap’) in quantity, and, secondly, exposure of the said collected raw sap to a cold containing surface which provides the loss of heat from the sap , such as a bulk container, gradually cooling said sap on and by said cold containing surface to the freezing point of water as a temperature sufficient to commence freezing of the sap liquid as water ice on that surface alone, continuing said cooling and freezing gradually to form a solid body of water ice on that surface alone and to separate a first sugars containing liquid component of the sap from the forming solid body of water ice on the cold containing surface, continuing said cooling and freezing steps gradually until the said first sugars containing liquid component reaches a substantially thickened or solid consistency, and, thirdly, separation of said first sugars containing liquid component from the said solid water ice body. By the process the raw sap is selectively cooled and directionally frozen outwards from the containing surface into the said collected sap quantity to cause a first sugars containing component maple liquid or gel to separately form both within the body of the collected raw sap and on the solid water ice body. The first sugars containing liquid component is an unfrozen and thick honey-like liquid syrup or sugar gel with a sugar content of about ⅔ of the 3% originally available in the raw sap. The cold surface is provided and maintained by the naturally occurring temperature drop as warm spring days turn into freezing cold nights at the point of collection or collection.

In another aspect the invention provides a process wherein the cooling and freezing on the containing cold surface alone is accompanied by maintenance of the balance of the sap at a temperature whereat there is little or no tendency for the sap to form a slurry of ice crystals, preferably by restricting heat loss or by providing a slightly elevated temperature in the liquid.

The invention also provides a further process and sugar or maple syrup product wherein separation of the gel is carried out either by mechanical means, such as scraping, or by exposure of the solid body to a low heat source opposite said containing cold surface which causes the water ice to commence melting, or a combination of both, and collecting said melt liquid having the highest concentration of remaining sugars running off first, preferably in a downward direction. Preferably the separation heat source applied to the gel is also naturally occurring as by the warming of a spring day, before, during or after the day warms to the point where sap begins to flow again in the trees.

By the process a portion of the melt liquid may be subjected to thermal cooking or curing into a traditional amber coloured flavourful sugar or maple syrup. Due to the now substantially reduced volumes thermal cooking or curing, or just a degree or warming, may be supplied by naturally occurring reduced carbon emissions sources such as on site solar energy.

In a further aspect the invention provides a separation process which may be combined with a pre-filtering of the sap so that the result will be bacteria free and remain clear and suitable for consumption even after weeks of refrigeration.

### Preferred Embodiments

With the preferred embodiment of the invention described raw sugar solution or tree sap, such as maple sap (herein ‘sap’) is collected in suitable quantities by conventional means such as tube collection systems or bucket runs.

According to step 1 of the preferred embodiment process of the invention the collected raw sap liquid (approximately 3% notable sugars) is exposed, preferably motionless, on-site to a containing cold surface and selectively gradually cooled at a rate of between 0.5 and 2.0 Celsius degrees per hour on that cold surface from a temperature just above the freezing point of water to a lower temperature such as −4.5 degrees Celsius sufficient to commence freezing of the sap liquid into a solid body of water ice adjacent to and on said cold surface alone. The cold surface is preferably an interior surface of a simple bulk container which is made of a heat conductive, preferably highly heat conductive, or non-insulating material such as metal. The low temperature of the interior containing surface is achieved by exposure of the exterior of said bulk container to a low temperature at and below the freezing point of water as ambient temperature or, alternatively, as an artificially cooled or refrigerated structures either stationary or in relative motion in respect of the sap.

Most preferably the containing cold surface is provided by the ambient air conditions on site cooling the exterior of a heat conductive bulk container as the warmth of the day required for the sap to flow turns into the cold of an early springtime evening and night. Heat conduction is sufficient to cause water ice accumulations on the interior of the container, the containing surface, alone as part of the present invention.

Further preferably the sap liquid is maintained at a temperature whereat no significant formation of ice slurry within the sap liquid. No exposed surface (non-containing surface) icing occurs during the process.

The gradual cooling of step 1 is continued as a 1 st liquid component of the directional progressive freezing process of the invention is separated, preferably with a substantial upward or diagonal component, alone or in combination, from the partially formed and continuously forming solid body of, principally, frozen water ice crystals and ice referred to collectively as ‘water ice’.

The cooling of step 1 is further continued until the remaining unfrozen liquid constituent which is not part of the solid water ice body on the containing surface reaches a suitable consistency. This consistency may be selected to be a thickened liquid, or a semi-solid, but is preferably that of a unfrozen and thick honey-like liquid syrup herein called ‘gel’ with a sugar content of about ⅔ of the 3% originally available in the sap and as much as approximately 46% of the gel volume.

Most preferably the cooling exposure of step 1 is carried out so as to provide a gradually decreasing sap temperature on and adjacent the said cold containing surface.

Further preferably the cooling of step 1 is carried out from the outside and contained surface of the sap liquid so that the body of the collected sap liquid freezes inwards from that surface and upwards to the exclusion of freezing in a downward direction from a surface exposed to ambient air or other surfaces and causes the sugar gel to form and remain substantially on the surface of the said solid body of water ice.

Further preferably the collected sap may be pre-filtered to reduce components of the naturally occurring sap product in the final resultant.

According to step 2 of the preferred embodiment process of the invention, the gel is then removed from the water ice, preferably mechanically as by scraping or vacuum suction, and set aside. Preferably the separation step of the process occurs in the small hours of the springtime morning as daylight returns to the site and warmth returns to repeat the daily cycle.

According to step 3 of the preferred embodiment process of the invention, the water ice, now substantially a frozen solid with greatly reduced sugars content, is exposed to a gentle heat source principally opposite to said cold containing surface to provide an increasing temperature, preferably slowly increasing uniformly over an area of the solid ice body, so as to cause the sap water ice to commence a slow melting preferably confined opposite said cold containing surface. Higher sugars content sap water ice more preferably directly exposed to the increasing heat will melt fastest and provide a melt liquid having the highest concentration of any remaining sugars. These higher concentration melt liquids would be available for run off or for vacuum suction. Most preferably, the heat source is again the ambient air as it may be warmed by sunlight as the day progresses before, during and after the sap begins to run again. Alternatively, low carbon emission natural sources of energy such as on site solar energy may be used in steps 2 and 3.

Increasing the availability of heat or a higher temperature from the heat source will increasingly speed up the melting process and, correspondingly, melt-water dilution interferes with the sugar concentration in the result.

Preferably the temperature of the invention at all steps is limited to a low temperature consistent with limited or no biological activity within the sap, the gel or the melt product, such as below about 10 degree C. or, preferably, below about 4.5 degree C.

Most preferably at no time in the process of the invention are the sap, the gel or the solid water ice body rendered fully or partially into an ice slurry whether by freezing at 1 st instance or by grinding, hammering or centrifuging.

Preferably step 3 is preferably carried out with the water ice in an inverted position so that the melt liquid, forming sugar syrup, may be predictably and simply separated and set aside. Separation of the first ⅔ of this melted syrup will provide a sugar content of about 15% (that is approximately 81% of the available sugars) and the balance of the water ice with only trace sugar.

Further preferably the heat source exposure of step 3 is limited to the now-inverted surface of the sap ice with the highest sugar content.

According to step 4 of the preferred embodiment process of the invention, the melting sap ice is predictably captured below the frozen water ice solid of step 3.

In a further preferred embodiment of the process, the separation in step 3 is carried out in multiple sequential small increments, each providing decreasing sugars content as the melting is continued.

In a still further embodiment of the preferred embodiment process of the invention the sweeter of the separated amounts of melted syrup are processed again according the preferred embodiments of the invention. This repetition with the sugars syrup results in further capture of approximately ⅓ of the remaining sugar. This may be added to the already captured ⅔ of the originally available sugar. These further steps may occur over a period of several days in ambient on-site conditions.

Although the process may be continued through further repetitions it has been found that the balance of the melt from step 3 contains only traces of useable sugar.

Most preferably with the preferred embodiment process of the invention almost all of the total sugar content of the raw maple sap is extracted after 2 freeze and thaw cycles.

In a further embodiment of the invention at step #1 the sap is exposed to an enclosing or partially enclosing (herein “containing”) cold surface for a sufficiently long period that the bulk of the sap becomes a frozen solid body of water ice. This solid ice body may be surrounded by the gel. In this embodiment an additional step in the process may be included whereby the exterior gel is removed and the remaining solid water ice body is mechanically broken up into manageable pieces but not ground or turned to a slurry state. The remaining portions of the broken solid body are laid out on a second cold surface prior to the heat exposure. In the case of a vertical cylindrical cold containing surface the solid body is formed in a tubular fashion with a decreasing internal diameter. The gel will remain on the ice surface but a portion may pool at the bottom and/or in a central location, or both, and another portion may locate at other locations around the solid body. In such cases, the additional step of mechanical break up is required to retrieve gel prior to the heating step of the invention.

Once sugar extraction has been completed the extracted liquids (which remain clear throughout) are heated temporarily, such as by on site low carbon footprint energy sources, such as solar, to cure the maple syrup to the completed amber coloured nectar of the invention.

Testing shows that a typical maple sap with 3 degree Brix sugar content processed according to invention at −1 through +2 degree C. will have the highest resulting sugar concentration. Including the 1 st ⅓ of the melted solid body will readily capture 81% of the available sugar. A sugar concentration of 73 percent (73 degree Brix) was readily obtained in step 2 with the sap frozen and the gel dripped off the resulting solid body with both steps at −18 degree C.

While particular embodiments of the invention have been described, it will be understood, of course, that the invention is not limited thereto, and that many obvious modifications and variations can be made, and that such modifications and variations are intended to fall within the scope of the appended claims.

What is claimed is:

1. A method of progressive freeze-concentration of raw sugary syrup comprising:
(a) collecting a volume of a raw sugary syrup within a cold containing surface;
(b) exposing said raw syrup to said cold containing surface;
(c) gradually reducing the temperature of said cold containing surface from the freezing point of water into ice towards −4.5 degrees Celsius;
(d) gradually cooling said raw syrup by said cold containing surface to commence freezing out of water ice only on said surface;
(e) continuing said gradual cooling of said raw syrup to progressively freeze-form a solid body of water ice inwardly from said water ice frozen out on said containing surface;
(f) maintaining the said volume of sugary syrup as a liquid substantially free from ice crystal formations as a sugars containing liquid component separate from said solid body;
(g) continuing said gradual cooling and progressive freeze-forming until said sugars containing liquid component reaches a thickened consistency;
(h) maintaining said solid body of said water ice and mechanically or thermally separating said sugars containing liquid component from said solid body.

2. A method of progressive freeze-concentration of raw sugary syrup as in claimed in claim 1 wherein the said gradual temperature reduction is provided by a naturally occurring spring heat and thaw cycle.

3. A method of progressive freeze-concentration of raw sugary syrup as claimed in claim 1 wherein the said gradual temperature reduction is no more than 2 celsius degrees per hour.

4. A method of progressive freeze-concentration of raw sugary syrup as claimed in claim 3 wherein the said gradual temperature reduction is no more than 1 celsius degree per hour.

5. A method of progressive freeze-concentration of raw sugary syrup as claimed in claim 4 wherein the said gradual temperature reductions is no more than 0.5 Celsius degrees per hour.

6. A method of progressive freeze-concentration of raw sugary syrup as claimed in claim 1 wherein said containing surface is heat conductive.

7. A method of progressive freeze-concentration of raw sugary syrup as claimed in claim 6 wherein said gradual cooling and progressive freeze-forming is upwardly from said cold containing surface into said liquid component.

8. A method of progressive freeze-concentration of raw sugary syrup as claimed in claim 1 wherein said liquid component is maintained at a temperature slightly higher than the said containing surface.

9. A method of progressive freeze-concentration of raw sugary syrup as claimed in claim 1 wherein said volume of raw sugary syrup is maintained motionless in relation to said cold containing surface.

10. A method of progressive freeze-concentration of raw sugary syrup as claimed in claim 1 wherein said thickened consistency has a sugars component of 66 degrees Brix or more.

11. A method of progressive freeze-concentration of raw sugary syrup as claimed in claim 10 wherein said thickened consistency is in the form of a gel.

12. A method of progressive freeze-concentration of raw sugary syrup as claimed in claim 3 wherein said sugars containing liquid component separate from said solid body is also exposed to a non-containing ambient atmosphere.

13. A method of progressive freeze-concentration of raw sugary syrup as claimed in claim 12 wherein said thickened consistency forms at an upper surface of said liquid component exposed to said ambient atmosphere.

14. A method of progressive freeze-concentration of raw sugary syrup as claimed in claim 1 wherein said raw sugary syrup is raw tree sap.

15. A method of progressive freeze-concentration of raw sugary syrup as claimed in claim 14 wherein said raw tree sap is maple tree sap.

16. A method of progressive freeze-concentration of raw sugary syrup as claimed in claim 1 wherein said solid body of water ice is subsequently exposed to a low heat source away from said cold containing surface and collecting the melt liquid.

17. A method of progressive freeze-concentration of raw sugary syrup as claimed in claim 1 wherein said solid body of water ice is substantially pure water.

18. A method of progressive freeze-concentration of raw sugary syrup as claimed in claim 17 wherein said substantially pure water contains sugars at a reduced density from the density of said sugars in said liquid component.
